(19) United States
(12) Patent Application Publication
(10) Pub. No.: US 2026/0205544 A1
(43) Pub. Date: Jul. 16, 2026

(54) AUTOMATED COMMUNICATION SYSTEMS

(71) Applicant: Optum, Inc., Minnetonka, MN (US)

(72) Inventors: Vikas Dixit, Palwal (IN); Ayan Sengupta, Noida (IN); Sudhanshu Sharma, Bangalore (IN); Abhishek Verma, Sugar Land, TX (US); Julie Zhu, Maple Grove, MN (US)

(21) Appl. No.: 19/018,772

(22) Filed: Jan. 13, 2025

(51) Int. Cl. H04M 3/51; G06N 3/0455; G06Q 50/60

(52) U.S. Cl. CPC H04M 3/5133; G06N 3/0455; G06Q 50/60; H04M 2203/357

(57) ABSTRACT

A method comprising: obtaining a graph comprising a plurality of nodes and a plurality of edges, wherein: the nodes include behavior nodes that correspond to respective behavior reasons in a plurality of predefined behavior reasons, the edges correspond to transitions between the nodes and are associated with weights; obtaining one or more interaction records, wherein the one or more interaction records are records of interactions of representatives of an organization with a current client; applying a trained machine learning (ML) model to the one or more interaction records to identify one or more behavior reasons associated with the current client; generating a behavior vector based on the one or more behavior reasons associated with the current client; and performing a communication action based on the graph and the behavior vector.

### TECHNICAL FIELD

This disclosure relates to automated communication systems.

### BACKGROUND

Organizations use automated communication systems to communicate with various types of clients, such as constituents, members, and other types of people. Example types of automated communication systems include automated mail-stream systems that select physical documents for insertion into a mail-stream for delivery to people. Another example of an automated communication system is a call center management system that selects clients to receive phone calls and provides scripts for representatives to use when communicating with clients.

### SUMMARY

The present disclosure describes techniques that improve automated communication systems. As described herein, a computing system may implement an automated communication system. The computing system may identify behavior reasons associated with clients and automatically customize communications to the clients based on the identified behavior reasons. For example, the computing system may obtain (e.g., retrieve or generate) a graph comprising a plurality of nodes and a plurality of edges. The nodes include behavior nodes that correspond to respective behavior reasons in a plurality of predefined behavior reasons. The predefined behavior reasons may be reasons why clients behave in a specific way (e.g., with reluctance, eagerness, hesitation, etc.) with respect to a service, product, or program available to the clients. The edges correspond to transitions between the nodes and are associated with weights. For each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node. Additionally, the computing system may obtain one or more interaction records. The one or more interaction records are records of interactions of representatives of an organization with a current client. The computing system may apply a trained machine learning (ML) model to the one or more interaction records to identify one or more behavior reasons associated with the current client. Furthermore, the computing system may generate a behavior vector based on the one or more behavior reasons associated with the current client. The computing system may perform a communication action based on the graph and the behavior vector. Performing communication actions based on the graph and the behavior vector may improve various aspects of the automated communication system, such as reducing delivery of wasteful documents or emails, wasting time and computing resources during real-time voice or text interactions, and so on.

In one example, this disclosure describes a computer-implemented method comprising: obtaining, by one or more processors, a graph comprising a plurality of nodes and a plurality of edges, wherein: the nodes include behavior nodes that correspond to respective behavior reasons in a plurality of predefined behavior reasons, the predefined behavior reasons being reasons for behaviors of clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node; determining, by the one or more processors, a spatial similarity score based on the graph; obtaining, by the one or more processors, one or more interaction records, wherein the one or more interaction records are records of interactions involving a current client; applying, by the one or more processors, a trained machine learning (ML) model to the one or more interaction records to identify one or more behavior reasons associated with the current client; generating, by the one or more processors, a behavior vector based on the one or more behavior reasons associated with the current client; computing, by the one or more processors, based on behavior vector of the current client, pairwise contextual similarity scores for behavior reasons associated with the current client; determining a behavior consistency score for the current client based on the pairwise contextual similarity scores and the spatial similarity score; classifying, by the one or more processors, based on the behavior consistency score, the current client into a category; and performing, by the one or more processors, a communication action with respect to the current client based on the category.

In another example, this disclosure describes a computing system comprising: one or more processors; and one or more memories storing processor-executable instructions that, when executed by the one or more processors, cause the one or more processors to perform operations comprising: obtaining a graph comprising a plurality of nodes and a plurality of edges, wherein: the nodes include behavior nodes that correspond to respective behavior reasons in a plurality of predefined behavior reasons, the predefined behavior reasons being reasons for behaviors of clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node; determining a spatial similarity score based on the graph; obtaining one or more interaction records, wherein the one or more interaction records are records of interactions involving a current client; applying a trained machine learning (ML) model to the one or more interaction records to identify one or more behavior reasons associated with the current client; generating a behavior vector based on the one or more behavior reasons associated with the current client; computing, based on behavior vector of the current client, pairwise contextual similarity scores for behavior reasons associated with the current client; determining a behavior consistency score for the current client based on the pairwise contextual similarity scores and the spatial similarity score; classifying, based on the behavior consistency score, the current client into a category; and performing a communication action with respect to the current client based on the category.

In another example, this disclosure describes one or more non-transitory computer-readable storage media having processor-executable instructions stored thereon that, when executed by one or more processors, cause the one or more processors to: obtain a graph comprising a plurality of nodes and a plurality of edges, wherein: the nodes include behavior nodes that correspond to respective behavior reasons in a plurality of predefined behavior reasons, the predefined behavior reasons being reasons for behaviors of clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node; determine a spatial similarity score based on the graph; obtain one or more interaction records, wherein the one or more interaction records are records of interactions involving a current client; apply a trained machine learning (ML) model to the one or more interaction records to identify one or more behavior reasons associated with the current client; generate a behavior vector based on the one or more behavior reasons associated with the current client; compute, based on behavior vector of the current client, pairwise contextual similarity scores for behavior reasons associated with the current client; determining a behavior consistency score for the current client based on the pairwise contextual similarity scores and the spatial similarity score; classify, based on the behavior consistency score, the current client into a category; and perform a communication action with respect to the current client based on the category.

The details of one or more aspects of the disclosure are set forth in the accompanying drawings and the description below. Other features, objects, and advantages of the techniques described in this disclosure will be apparent from the description, drawings, and claims.

### BRIEF DESCRIPTION OF THE DRAWINGS

FIG. 1 is a block diagram illustrating an example system in accordance with one or more aspects of this disclosure.

FIG. 2 is a conceptual diagram illustrating a graph in accordance with one or more techniques of this disclosure.

FIG. 3 is a flowchart illustrating an example operation of a computing system in accordance with one or more techniques of this disclosure.

FIG. 4 is a flowchart illustrating an example operation of a computing system that performs a communication action based on a category of a client, in accordance with one or more techniques of this disclosure.

### DETAILED DESCRIPTION

There are several different types of automated communication systems, such as automated call center management systems, automated mail systems, and other types of systems for automating communication between organizations and individual people. Automated communication systems are commonly used to encourage people (referred to herein as “clients”) to accept a service that is available to the clients. In a healthcare context, examples of services may include healthcare services, home visits, pharmacy benefits, exercise programs, and so on. However, clients may exhibit a variety of behaviors and express a variety of reasons for such behaviors during interactions. For example, a client may be reluctant or eager to accept a service for a variety of reasons. For instance, clients may be reluctant to accept a service because they are experiencing housing instability, because they are not interested in the service, because they are too busy, because they are out of town, pet care issues, and so on. If an automated communication system does not take a client's behavior reasons into account when performing communication actions, the automated communication system may be less effective in communicating with the client. For instance, the automated communication system may be less effective in encouraging the client to accept the service.

This disclosure describes automated communication systems configured to perform communication actions based in part on behavior reasons expressed by clients. The techniques may be used to improve multiple different applications. For example, the techniques may improve call center systems by prompting a representative to communicate selected dialog units to the client that may address the client's likelihood of accepting the service. In another example, the techniques may improve mail-stream operations by automatically inserting selected documents into a mail-stream for delivery to the client.

As described herein, a computing system may obtain a graph comprising a plurality of nodes and a plurality of edges. The nodes include behavior nodes that correspond to respective behavior reasons in a plurality of predefined behavior reasons. In some examples, the predefined behavior reasons are reasons why clients are reluctant to accept a service available to the clients. The edges correspond to transitions between the nodes and are associated with weights. For each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node. Furthermore, the computing system may obtain one or more interaction records. The one or more interaction records are records of interactions of representatives of an organization with a current client. The computing system may apply a trained ML model to the one or more interaction records to identify one or more behavior reasons associated with the current client. The computing system may generate a behavior vector based on the one or more behavior reasons associated with the current client. Furthermore, the computing system may perform a communication action based on the graph and the behavior vector. As described in detail below, performing the communication action based on the graph and the behavior vector may increase efficiency of systems for communicating with clients.

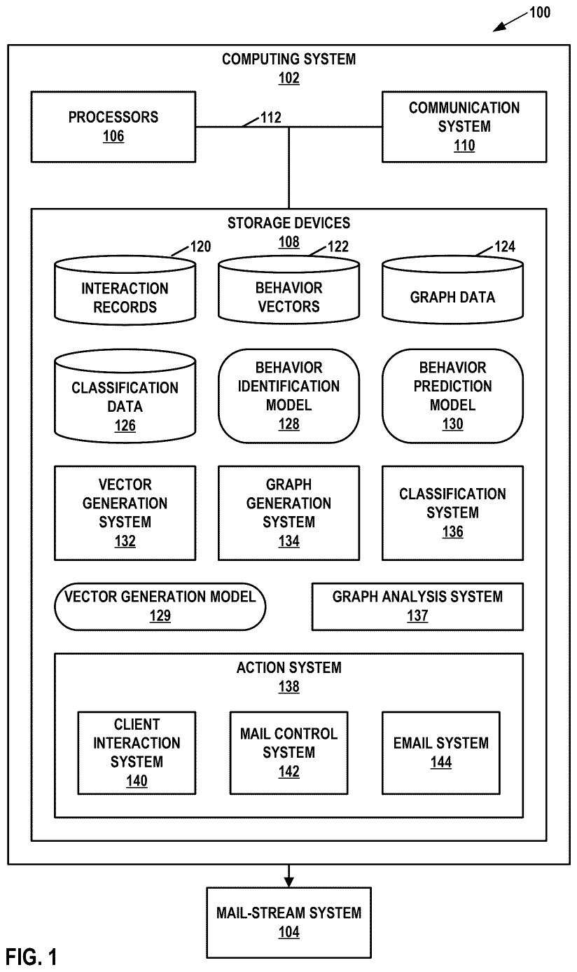

FIG. 1 is a block diagram illustrating an example system 100 in accordance with one or more aspects of this disclosure. In the example of FIG. 1, system 100 includes a computing system 102 and a mail-stream system 104. In other examples, system 100 may include more, fewer, or different components. For instance, in some examples, system 100 does not include mail-stream system 104. Computing system 102 includes one or more computing devices. Example types of computing devices include server devices, personal computers, mobile devices (e.g., smartphones, tablet computers, wearable devices), intermediate network devices, and so on. Computing system 102 and mail-stream system 104 may be connected via one or more wired or wireless connections and may be configured to send and receive data and commands between each other.

In the example of FIG. 1, computing system 102 includes one or more processors 106, one or more storage devices 108, a communication system 110, and one or more communication channels 112 that facilitate exchange of information between processors 106, storage devices 108, and communication system 110. Processors 106 may be distributed among one or more devices of computing system 102. Processors 106 may be implemented in circuitry and may include microprocessors, application-specific integrated circuits, digital signal processors, artificial intelligence (AI) accelerators, or other types of circuits.

Storage devices 108 may store data. Storage devices 108 may include volatile memory and may therefore not retain stored contents if powered off. Examples of volatile memories may include random access memories (RAM), dynamic random access memories (DRAM), static random access memories (SRAM), and other forms of volatile memories known in the art. Storage devices 108 may include non-volatile memory for long-term storage of information and may retain information after power on/off cycles. Examples of non-volatile memory may include flash memories or forms of electrically programmable memories (EPROM) or electrically erasable and programmable (EEPROM) memories. In some examples, processors 106 may read and execute instructions stored by storage devices 108. Storage devices 108 may be distributed among multiple computing devices. Different elements shown in FIG. 1 as being in storage devices 108 may be stored in storage devices on different devices. Thus, computing system 102 may comprise a system of interacting computing devices that perform different tasks.

Communication system 110 may enable computing system 102 to send data to and receive data from one or more other devices. Communication system 110 may enable computing system 102 to use wireless or non-wireless communication technologies. For instance, communication system 110 may enable computing system 102 to communicate using one or more of various types of wireless technology, such as a BLUETOOTH™ technology, 3G, 4G, 4G LTE, 5G, ZigBee, WI-FI™, Near-Field Magnetic Induction (NFMI), ultrasonic communication, infrared (IR) communication, or another wireless communication technology. In some examples, communication system 110 may enable hearing instrument 102A to communicate using a cable-based technology, such as a Universal Serial Bus (USB) technology, Ethernet, and so on. Communication channels 112 may include busses, wired or wireless communication channels, network communication links, and so on.

In the example of FIG. 1, storage devices 108 store interaction records 120, behavior vectors 122, graph data 124, classification data 126, a behavior identification model 128, a vector generation model 129, and a behavior prediction model 130. Additionally, storage devices 108 may include processor-executable instructions associated with a vector generation system 132, a graph generation system 134, a classification system 136, a graph analysis system 137, and an action system 138. In other examples, storage devices 108 may store data or instructions associated with more, fewer, or different models, systems, types of data, etc. Processors 106 may execute the processor-executable instructions associated with vector generation system 132, graph generation system 134, classification system 136, graph analysis system 137, and action system 138. For ease of explanation, this disclosure describes vector generation system 132, graph generation system 134, classification system 136, graph analysis system 137, and action system 138 as performing actions that are performed when processors 106 execute the instructions associated with vector generation system 132, graph generation system 134, classification system 136, graph analysis system 137, and action system 138.

Interaction records 120 include records of interactions of representatives of an organization with one or more clients. For instance, interaction records 120 may include transcripts of voice interactions between clients and representatives of the organization. In some examples, computing system 102 obtains audio data of voice interactions and generates the transcripts based on the audio data. In some examples, interaction records 120 may include written interactions, such as email messages or chat records. In some examples, computing system 102 generates interaction records 120 in real-time. For instance, computing system 102 may generate a transcript of a voice interaction while the voice interaction is ongoing.

Vector generation system 132 may generate behavior vectors 122 based on interaction records 120. Behavior vectors 122 are associated with clients. In some examples, multiple behavior vectors are associated with the same client and different points in time. A behavior vector is a vector comprising elements (e.g., weights) corresponding to a plurality of predefined behavior reasons. Vector generation system 132 may determine the values of the elements based on the behavior reasons identified in the interaction data for an interaction. In some examples, a value of an element in a behavior vector associated with a client may indicate whether the client has the behavior reason corresponding to the element. For example, a value of a first element of a behavior vector associated with a client may indicate whether the client is reluctant to accept the service because of being too busy, a value of a second element of the behavior vector may indicate whether the client is reluctant to accept the service because the client will not be home, and so on. In some examples, the values of elements in a behavior vector may be associated with levels of importance of the corresponding behavior reasons to the client during an interaction.

As part of generating behavior vectors 122, vector generation system 132 may provide interaction records 120 as input to behavior identification model 128. Behavior identification model 128 includes one or more trained machine learning models that identify behavior reasons based on interaction records 120. In some examples, behavior identification model 128 is a large language model (LLM), such as GPT-4o from OpenAI, Inc., Gemini from Google LLC, Claude from Anthropic PBC, LLAMA from Meta, Inc., and so on. In such examples, behavior identification model 128 may provide prompts to the LLM that request the LLM to identify the behavior reasons. For instance, a prompt may specify “you are an assistant that detects reasons why a client does not want a house call visit at their home. The possible topics could be—not interested, busy, already sees doctor.”

Behavior identification model 128 may be able to identify behavior reasons even if the reasons are not explicitly stated. Behavior identification model 128 may identify the behavior reasons from among a plurality of predefined behavior reasons. In some examples, behavior identification model 128 may identify the behavior topics in real time. In other words, vector generation system 132 may use behavior identification model 128 to identify behavior reasons explicitly or implicitly expressed in an interaction (e.g., a voice interaction or a chat interaction) while the interaction is still ongoing. To use behavior identification model 128 to identify the behavior reasons, vector generation system 132 may provide a prompt to behavior identification model 128 that includes a transcript and requests behavior identification model 128 to identify the behavior reasons.

In some examples, vector generation system 132 may use behavior identification model 128 to perform multistep reasoning to identify the behavior reasons. Multistep reasoning-based prompting involves guiding a large language model (LLM) through a series of logical steps to extract latent behavior topics from interaction records 120. This may help the behavior identification model 128 break down the complex task of identifying nuanced behavior reasons into smaller tasks. For instance, in some examples, vector generation system 132 may prompt behavior identification model to analyze call transcripts to identify behavior topics. The task is divided into smaller steps:
Step 1: Identify key phrases or sentences that indicate behavior.
Step 2: Classify these phrases into broader categories of behavior.
Step 3: Extract latent or indirect behavior topics that are implied but not explicitly stated.
   A prompt provided by vector generation system 132 may include these intermediate steps to guide the LLM through a logical sequence, ensuring systematic extraction.

Vector generation system 132 may generate behavior vectors 122 based on the behavior reasons identified by behavior identification model 128. In some examples, vector generation system 132 may use a vector generation model 129 to generate behavior vectors 122 based on the identified behavior reasons. In other words, vector generation system 132 may apply vector generation model 129 to generate the behavior vector based on the one or more behavior reasons associated with the current client. Vector generation model 129 may be a trained ML model. For example, vector generation system 132 may comprise a Bidirectional Encoder Representations from Transformers (BERT) model. A BERT model is a deep learning model for natural language processing. The BERT may read text in both directions simultaneously, allowing the BERT model to understand the contexts of words based on their surrounding words. The BERT model uses a transformer architecture for encoding. In this example, vector generation system 132 may provide, as input to vector generation model 129, data indicating the behavior reasons identified by behavior identification model 128 for an interaction and also a transcript of the interaction. Output of vector generation system 132 may include a behavior vector that includes elements corresponding to potential behavior reasons, where, for each of the elements, a value of the element may indicate a relative importance of the potential behavior reason to the client during the interaction. The BERT may be trained with masked language modeling objective on the reluctance topics extracted in the previous step. Therefore, post-training the BERT model should be able to capture the semantics of different reluctance topics required in the subsequent steps.

Graph generation system 134 may generate graph data 124 based on behavior vectors associated with multiple clients. For instance, graph generation system 134 may generate graph data 124 based on historical behavior vectors generated based on a potentially large number of interactions. Graph data 124 represents a graph comprising a plurality of nodes and a plurality of edges. The nodes include behavior nodes that correspond to respective behavior reasons in a plurality of predefined behavior reasons. The predefined behavior reasons are reasons why clients are reluctant to accept a service available to the clients. The edges correspond to transitions between the nodes and are associated with weights. For each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node. In some examples, the graph also includes one or more acceptance nodes that correspond to an acceptance behavior, such as acceptance of a product, service, agreement to participate in a program, and so on. Edges connecting behavior nodes to acceptance nodes may be associated with weights that correspond to probability of the clients accepting the service after having the behavior reasons associated with the behavior nodes.

Classification system 136 may classify clients into a plurality of categories based on the behavior vectors associated with the clients. For instance, as described in greater detail below, classification system 136 may classify clients into a concordant category and a divergent category. Clients in the concordant category tend to have consistent behavior reasons across interactions. Clients in the divergent category tend to have different behavior reasons across interactions.

Action system 138 performs a communication action based on behavior vectors 122. A communication action is an action to communicate information to a client. In different examples, action system 138 may perform different types of communication actions. In the example of FIG. 1, action system 138 includes a client interaction system 140 that facilitates real-time interactions between clients and representatives of an organization. For examples, during a real-time interaction, client interaction system 140 may select a dialog unit to provide to the representative based on the one or more next behavior reasons and output the selected dialog unit to the representative. For instance, client interaction system 140 may be a call center management system that makes phone calls to clients or receives phone calls from clients and provides a script to representatives to use when talking with the client. In this example, the communication action may involve the call center management system automatically selecting a predefined dialog unit to provide to the representative based on one or more behavior reasons indicated in one or more behavior vectors associated with the client. The dialog unit may be a predefined section of script. For example, the dialog unit may include text telling the representative what to say. The call center management system output the selected dialog unit to the representative. For instance, the call center management system may prompt the representative to communicate the selected dialog unit to the client during a real-time interaction (e.g., voice interaction, chat interaction, etc.) between the representative and the client. In the context of a chat interaction, client interaction system 140 may present the selected dialog unit and prompt the representative to confirm that they would like to send the selected dialog unit, edit the selected dialog unit, or provide a different textual response. In this way, client interaction system 140 may provide appropriate dialog units to the representative, in real time, to appropriately address the client's behavior reasons. This may significantly improve the effectiveness of the call center management system.

Furthermore, in some examples, action system 138 includes a mail control system 142. Mail control system 142 is configured to determine a document from a plurality of documents based on one or more behavior vectors associated with a client. The determined document may have content designed specifically to address the client's behavior reasons. Mail control system 142 may output commands to mail-stream system 104 to cause mail-stream system 104 to physically insert a physical copy of the determined document into a mail stream for delivery to the client. Mail-stream system 104 may include one or more machines that physically select and move copies of documents into the mail stream. Inserting a document into a mail stream may involve printing a copy of the document or selecting a copy of a preprinted document, adding an address of the client to a document or an envelope thereof, and placing the document in a location for pickup for delivery. While mail is discussed, other forms of delivery are included within the term mail stream, such as courier, package delivery service, etc. Controlling mail-stream system 104 may improve mail-stream operations by targeting more appropriate documents to clients, which may reduce waste.

In some examples, action system 138 includes an email system 144 and the communication action may include email system 144 selecting an email template based on the behavior vectors and sending an email to the client based on the selected email template. For instance, email system 144 may select an email template having content designed specifically to address the client's behavior reasons. This may improve the efficiency of email system 144 because fewer resources are expended on sending emails that do not address the client's reasons for being reluctant to accept a service.

In some examples, action system 138 may use graph data 124 and one or more behavior vectors associated with a client to predict one or more next behavior reasons that the client may have. That is, the client may shift from one behavior reason to another behavior reasons from one interaction to the next interaction. However, clients are likely to shift between behavior reasons in a relatively predictable way. The weights associated with edges in graph data 124 are based on probabilities of clients transitioning between behavior reasons, and from reluctance behavior reasons to acceptance. Thus, action system 138 may anticipate one or more behavior reasons the client will likely have next and perform a communication action that addresses the one or more behavior reasons. For instance, if the next behavior reason is likely to be a lack of transportation, the communication action may provide information to the client about available transportation options.

In some examples, action system 138 may use behavior prediction model 130 to predict one or more next behavior reasons based on a sequence of behavior vectors associated with a client. In other words, action system 138 may apply behavior prediction model 130 to a sequence of behavior vectors associated with the client to predict a next behavior topic associated with the client. Action system 138 may perform a communication action based on the next behavior reason. For example, client interaction system 140 may select a dialog unit that preemptively addresses the next behavior reason. Mail control system 142 may select a document that preempts addresses the next behavior reason. Email system 144 may send an email that addresses the next behavior reason.

Behavior prediction model 130 may include one or more trained ML models. For example, from the BERT model, vector generation system 132 may calculate vector embeddings for each reluctance topic. In next step, action system 138 may use an appropriate language model (an autoregressive model), that takes a sequence of vectors and predicts the next reluctance topic. The model can be trained with an autoregressive loss on the training data, where computing system 102 have behavior topics for a client in historical data.

In some examples, action system 138 may use graph data 124 to determine a most-likely path through the graph from a node associated with a client's current behavior reason to an acceptance node of the graph. The communication action may provide the client with information to address the client's current behavior reason and behavior reasons along the most-likely path. For instance, email system 144 may generate and send an email that includes content that addresses the client's current behavior reason and the behavior reasons along the most-likely path. Sending such an email message may reduce the number of emails that are sent to the client, increasing efficiency and client satisfaction. Similarly, mail control system 142 may prepare or select a document that includes content that addresses the client's current behavior reason and the behavior reasons along the most-likely path, and command mail-stream system 104 to insert the document into the mail stream.

In some examples, client interaction system 140 may automatically output, for display to a representative, a set of dialog units that address the client's current behavior reason and the behavior reasons along the most-likely path. In some examples, client interaction system 140 outputs the set of dialog units in advance of an interaction with the client. This may enable the representative to prepare for an interaction with the client. In some examples, client interaction system 140 may output one or more dialog units of the set of dialog units for display to the representative during a real-time interaction with the client, allowing the representative to provide information to the client to anticipate the client's likely subsequent behavior reasons. This may accelerate the process of getting the client to accept the service.

In some examples where client interaction system 140 includes a call center management system, the call center management system may include an auto-dialer system. The auto-dialer system automatically dials the phone numbers of clients in a manner that is far faster than a human would be capable of doing. In such examples, client interaction system 140 may determine, based on behavior vectors associated with clients, current nodes in the graph associated with the client. For each of the clients, a current node associated with the client is a node of the graph that corresponds to a current behavior reason of the client. Client interaction system 140 utilizes the graph to determine lowest-cost paths for the clients through the graph from the current nodes associated with the clients to the one or more acceptance nodes. The cost of a path from a current node to an acceptance node may be a sum of link costs of edges on the path. The link cost of an edge may be equal to 1 minus the probability of transitioning between nodes along the path. Thus, paths with lower costs are more likely ways for clients to reach acceptance nodes than paths with higher costs. If a first client has a lower cost path to an acceptance node than a second client, the first client is more likely to reach the acceptance node. Thus, by identifying a lowest-cost path for each of the clients, client interaction system 140 may identify clients that are more or less likely to reach an acceptance node. Accordingly, client interaction system 140 may configure the auto-dialer system to prioritize dialing the clients based on costs of the lowest-cost paths for the clients. For instance, client interaction system 140 may configure the auto-dialer system to prioritize dialing the phone numbers of clients that are more likely to reach an acceptance node. Alternatively, client interaction system 140 may configure the auto-dialer system to prioritize dialing the phone numbers of clients that are less to reach an acceptance node. In this way, functioning of the auto-dialer system can be improved so that the auto-dialer system prioritizes targeted groups of clients, thereby improving its efficiency.

To summarize, client interaction system 140 may determine, based on behavior vectors 122, current nodes of the graph associated with the clients. For each of the clients, a current node associated with the client is a node of the graph that corresponds to a current behavior reason of the client. Client interaction system 140 may utilize the graph to determine lowest-cost paths for the clients through the graph from the current nodes associated with the clients to the one or more acceptance nodes. Client interaction system 140 may configure an auto-dialer system to prioritize dialing the clients based on costs of the lowest-cost paths for the clients.

In some examples, mail control system 142 may perform a similar lowest-cost path analysis for determining which clients to send documents to determine which documents to send to the clients. Thus, in some examples, mail control system 142 may determine, based on the behavior vector associated with the client, a current node associated with the client. The current node associated with the client is a node of the graph that corresponds to a current behavior reason of the client. Mail control system 142 may utilize the graph to determine a lowest-cost path for the client through the graph from the current node associated with the client to the one or more acceptance nodes. Mail control system 142 may determine a document from a plurality of documents based on the lowest-cost path for the client. Mail control system 142 may output commands to one or more machines (e.g., mail-stream system 104) to cause the one or more machines to physically insert a physical copy of the determined document into a mail stream for delivery to the client. In some examples, mail control system 142 may prioritize sending documents to clients with lower cost paths than higher cost paths, or vice versa.

In some examples, client interaction system 140 may perform a similar lowest-cost path analysis for selecting applicable dialog units. For instance, during a real-time interaction between the representative and a current client, client interaction system 140 may determine, based on the behavior vector associated with the current client, a current node associated with the current client. Client interaction system 140 may utilize the graph to determine a lowest-cost path for the current client through the graph from the current node associated with the current client to the one or more acceptance nodes. Client interaction system 140 may select, based on the lowest-cost path for the client, one or more applicable dialog units from among a plurality of dialog units. For example, client interaction system 140 may select dialog units that anticipate and address behavior reasons along the lowest-cost path for the client. Client interaction system 140 may output, for display on a display device, the one or more applicable dialog units.

In some examples, action system 138 may perform a communication action based on a category associated with the client. As mentioned above, classification system 136 may classify clients into categories based on behavior vectors associated with the clients. For example, action system 138 may perform a first communication action if the client is a concordant category and a second communication action if the client is in a divergent category.

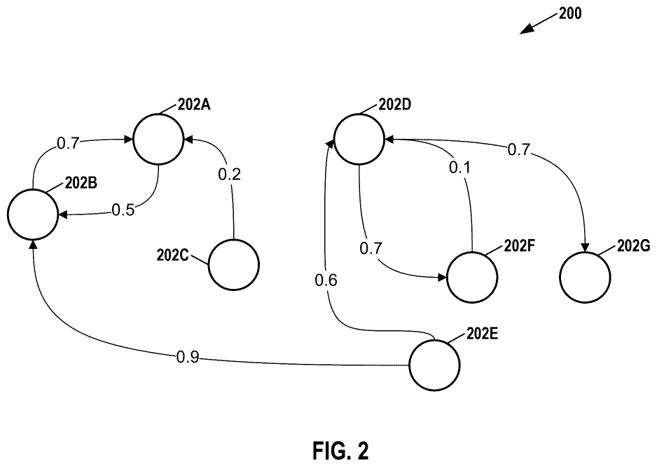

FIG. 2 is a conceptual diagram illustrating a graph 200 in accordance with one or more techniques of this disclosure. Graph 200 includes nodes 202A-202G (collectively, “nodes”) and edges. Graph 200 may be generated based on information in behavior vectors associated with multiple clients. Nodes 202 are represented as circles and the edges are represented by arrows. Nodes 202 may include behavior nodes and acceptance nodes. For example, nodes 202B-202G may be behavior nodes and nodes 202A and 202G may be acceptance nodes. The behavior nodes may correspond to different behavior reasons. For example, node 202B may correspond to being busy, node 202C may correspond to being out of town, node 202D may correspond to not being interested, node 202E may correspond to housing instability, and node 202F may correspond to address issues. The numbers associated with the edges may indicate weights associated with the edges.

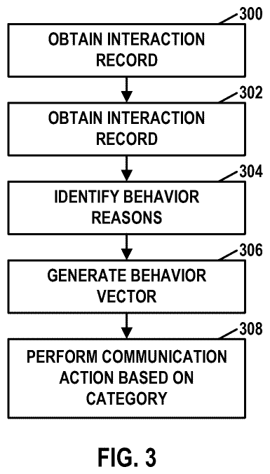

FIG. 3 is a flowchart illustrating an example operation of computing system 102 in accordance with one or more techniques of this disclosure. In the example of FIG. 3, vector generation system 132 may obtain a graph comprising a plurality of nodes and a plurality of edges (300). The nodes include behavior nodes that correspond to respective behavior reasons in a plurality of predefined behavior reasons. The predefined behavior reasons may include reasons why clients are reluctant to accept a service, program, or product available to the clients. In other examples, the predefined behavior reasons may include reasons why clients are eager to accept a service, program, or product available to the clients. The edges correspond to transitions between the nodes and are associated with weights. For each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node.

In some examples, graph generation system 134 of computing system 102 generates the graph. Graph generation system 134 may generate the graph based on historical behavior vectors. The historical behavior vectors may have been generated by vector generation system 132 based on interactions between representatives of an organization and clients. The historical behavior vectors may include elements corresponding to different behavior reasons. As part of generating the graph, graph generation system 134 may generate a node for each of the different behavior reasons. Additionally, graph generation system 134 may analyze the behavior reasons to determine transitions between behavior reasons and transitions from reluctance behavior reasons to acceptance. A reluctance behavior reason is a reason for being reluctant to accept a service, product, etc. Graph generation system 134 may generate edges that correspond to such transitions. Additionally, graph generation system 134 may quantify the transitions between behavior reasons and transitions from behavior reasons to acceptance. Graph generation system 134 may therefore determine probabilities of the transitions. Graph generation system 134 may determine weights for edges based on the probabilities of the transitions. For example, graph generation system 134 may determine a weight for an edge as 1 divided by the probability of the transition associated with the edge.

In some examples, graph generation system 134 generates weights or transition probabilities using a Hidden Markov Model (HMM). In such examples, it may be assumed that behavior reasons expressed in one interaction may influence behavior reasons expressed in subsequent interactions. Hence, an HMM may be used to capture the sequential nature of this behavior. Each behavior reason can be considered as an observable state, while the underlying member mindset influencing behavior reasons is represented as a hidden state. To train the HMM, historical data consisting of sequences of behavior reasons expressed by members across multiple interactions is utilized. The parameters of the HMM, including the transition probabilities between behavior reasons and emission probabilities of observing each behavior reason are estimated from the training data (e.g., historical occurrences of behavior reasons) using the techniques like the Baum-Welch algorithm.

The Baum-Welch algorithm is a specific case of the Expectation-Maximization (EM) algorithm. The Baum-Welch algorithm starts with initial guesses for the HMM parameters: transition probabilities, emission probabilities, and initial state probabilities. Next, a forward algorithm is applied to calculate the forward probabilities, which represent the probabilities of observing the sequence up to a certain point and being in a particular state at that point. Additionally, a backward algorithm is applied to calculate backward probabilities, which represent the probabilities of observing the remaining sequence from a certain point, given the state at that point. The Baum-Welch algorithm then performs a maximization step. During the maximization step, the forward and backward probabilities are used to estimate the expected number of transitions between states and update the transition probabilities accordingly. The expected number of times each observation is generated from each state and the emission probabilities are updated. The initial state probabilities are updated based on the forward probabilities at the first time step. The expectation steps and the maximization steps may be repeated until the parameters converge, meaning the changes in the parameters between iterations are below a certain threshold.

Once trained, the HMM enables the calculation of transition probabilities between behavior reasons from one interaction to another. These transition probabilities quantify the likelihood of transitioning from one behavior reason to another in subsequent interactions, capturing the sequential dependencies between behavior reasons. By leveraging the learned transition probabilities, the HMM can predict the most probable sequence of behavior reasons that a client is likely to exhibit in future interactions. This predictive capability may enable organizations to anticipate behavior reasons and tailor strategies accordingly.

Vector generation system 132 may obtain one or more interaction records (302). The one or more interaction records are records of interactions of representatives of an organization with a current client.

Vector generation system 132 may apply behavior identification model 128 (e.g., a trained ML model) to the one or more interaction records to identify one or more behavior reasons associated with the current client (304). For example, vector generation system 132 may provide the one or more interaction records to behavior identification model 128 with a prompt requesting behavior identification model 128 to identify the behavior reasons. Furthermore, vector generation system 132 may generate a behavior vector based on the one or more behavior reasons associated with the current client (306). For example, vector generation system 132 may apply vector generation model 129 to generate the behavior vector based on the one or more behavior reasons associated with the current client.

Action system 138 may perform a communication action based on the behavior vector and the graph (308). As described elsewhere in this disclosure, the communication actions may include selecting and outputting dialog units, selecting documents for insertion into a mail stream, sending emails, and so on.

Graph analysis system 137 may analyze the graph for one or more purposes. For example, graph analysis system 137 may determine one or more centrality measures for the graph. For example, graph analysis system 137 may calculate degree centrality for nodes of the graph. The degree centrality of a node is a measure of the importance of the node within the graph. Graph analysis system 137 may determine the degree centrality of a node based on the number of edges that connect the node to other nodes.

In some examples, graph analysis system 137 determines betweenness centrality for nodes of the graph. The betweenness centrality for a node is a measure in network analysis that quantifies the importance of the node based on the node's position within the shortest paths between other nodes. The betweenness centrality of nodes may identify the nodes that act as bridges or intermediaries within the graph. For instance, in the example of FIG. 2, node 202E may have high betweenness centrality because node 202E acts as a bridge between groups of nodes. Thus, behavior reasons that act as bridges between different clusters of behavior reasons may have relatively high betweenness centrality.

In some examples, graph analysis system 137 uses the graph to determine a Louvain modularity. The Louvain modularity is a method used to detect communities within large networks. The Louvain modularity aims to maximize a modularity score, which measures the density of connections within communities compared to connections between different communities. In other words, the Louvain modularity is an algorithm used for community detection, which partitions the graph into cohesive clusters or communities based on the strength of connections between nodes within and across clusters. For example, the Louvain modularity may identify a cluster of topics related to time-related behavior reasons, including “Busy schedule,” “Scheduling conflicts,” and “Time constraints.” These topics form a cohesive community due to their shared characteristics and frequent co-occurrences in behavior reasons.

By analyzing the graph, organizations may gain valuable insights into the structure and dynamics of reluctance or acceptance behavior among clients. Centrality measures may identify influential topics and bridge topics that play crucial roles in connecting different clusters or communities within the network. Community detection algorithms may reveal cohesive clusters of related behavior reasons, highlighting common themes or patterns observed in behavior reasons. The assignment of weights to edges based on the co-occurrence of behavior reasons may provide additional information about the strength of associations between topics, enabling a more nuanced analysis of behavior reasons.

For example, suppose centrality measures identify the topic “Pet concerns” as having high degree centrality in the graph, indicating its frequent occurrence and influence in behavior reasons. In this example, community detection algorithms may reveal a cluster of topics related to pet-related reluctance behavior reasons, including “Pet concerns,” “Housing restrictions,” and “Allergies.” This cluster represents a cohesive community within the graph, suggesting common themes among these behavior reasons. Additionally, edges between topics within this cluster may have higher weights, indicating strong associations between pet-related behavior reasons. Based on these insights, healthcare providers can develop targeted interventions to address pet-related behavior reasons and improve acceptance rates among members with such concerns. In general, centrality measures may be used to provide a holistic picture of behavior reasons in a population.

In some examples, the centrality measures may help identify topics that exert significant influence within the graph. For instance, “Belief in Being Already Healthy” might emerge as an influential topic through degree centrality analysis, indicating areas where targeted interventions, such as education on preventive healthcare or personalized health assessments, could be prioritized. Community detection algorithms may reveal cohesive clusters of related topics. For example, a cluster of topics related to perceptions of health, including “Belief in Being Already Healthy,” “Preventive Healthcare,” and “Regular Check-ups,” may suggest common themes among members' behavior reasons. Tailored interventions, such as health education campaigns or personalized health coaching, could then be developed to address these shared themes effectively. Furthermore, weighted edges between topics would indicate the strength of associations within the graph. Higher edge weights between behavior reasons related to perceptions of health would signify strong relationships, highlighting areas where targeted interventions, such as personalized health education materials or incentives for regular check-ups, could be particularly effective.

Clients may explicitly or implicitly express one or more behavior reasons over the course of one or more interactions. Thus, a client may be associated with a behavior reason set that indicates the one or more behavior reasons the client expressed over the course of an interaction. Classification system 136 may compute pairwise contextual similarity scores based on pairs of behavior reason sets. The pairwise contextual similarity score may be a pairwise cosine similarity score or another type of similarity score. The pairwise contextual similarity score for a pair of behavior reason sets may indicate a level of similarity between the behavior reasons expressed by the different clients. In some examples, classification system 136 calculates the contextual similarity score Si of a pair of behavior reason sets using the following equation:

$${S}_{i} = \frac{{\sum }_{k = 1}^{m} ( {w}_{i k} \cdot {w}_{j k} )}{\sqrt{{\sum }_{k = 1}^{m} {( {w}_{i k} )}^{2}} \cdot \sqrt{{\sum }_{k = 1}^{m} {( {w}_{j k} )}^{2}}}$$

In the equation above, m is the total number of unique behavior reasons in the behavior reason sets. wᵢₖ represents a weight value associated with a behavior reason k in an interaction i. The behavior vectors may include the weights. For instance, a behavior vector generated based on an interaction i may include weights for different potential behavior reasons, including behavior reason k (i.e., wᵢₖ). The weight value may correspond to an importance or relevance of each behavior reason within its respective interaction, effectively representing the behavior reason's position or significance in the multidimensional space defined by the behavior reasons.

Classification system 136 may calculate a behavior consistency score for a client based on the contextual similarity scores for the pairwise combinations of interactions involving the client. The behavior consistency score for the client may indicate how consistent the client's behavior reasons are over the course of multiple interactions. In some examples, classification system 136 may calculate the behavior consistency score for a client as an average of the contextual similarity scores for the pairwise combinations of interactions involving the client. For instance, classification system 136 may calculate the behavior consistency score for a client using the following equation:

$$B C S = \frac{{\sum }_{i = 1}^{n - 1} {\sum }_{j = i + 1}^{n} {S}_{i j}}{( \begin{matrix}n \\ 2\end{matrix} )}$$

In the equation above, n is the total number of interactions with the client. Sᵢⱼ represents a contextual similarity score for interactions i and j.

$$( \begin{matrix}n \\ 2\end{matrix} )$$

indicates normalization by a total number of pairs. Thus, BCS is an average score of all possible pairs of items.

Classification system 136 may use the behavior consistency scores for clients to classify the clients into two or more categories. Classification system 136 may classify the clients into categories based on comparisons of the behavior consistency scores with one or more thresholds. For example, classification system 136 may use the behavior consistency scores for the clients to classify the clients into a concordant group and a divergent category. Clients who consistently have the same behavior reasons may be classified into the concordant group and clients who do not consistently have the same behavior reasons may be classified into the divergent category. In this example, classification system 136 may classify a client into the concordant group if the behavior consistency score for the client is greater than a specific threshold and may classify the client into the divergent category if the behavior consistency score for the client is less than the specific threshold. For instance, in this example, there may be three interactions with the client. During the first interaction, the client may express that they are reluctant because of a busy schedule; during the second interaction, the client may express that they are reluctant because of health concerns; and during the third interaction, the client may express that they are reluctant because of house constraints. Since the client is expressing different behavior reasons in the three interactions, the contextual similarity scores between the three interactions will be low and the client's behavior consistency score will also be low. Accordingly, classification system 136 may classify the client into the divergent category.

Action system 138 may perform various actions based on the categories of a client. For example, mail control system 142 may cause mail stream system 104 to insert different documents into a mail-stream for delivery to a client depending on the category of the client. In another example, client interaction system 140 may display different dialog units to a representative during a subsequent interaction depending on the category of the client. In some examples, email system 144 may send different emails to client dependent on the categories of the clients.

Thus, classification system 136 may compute, based on behavior vectors of the current client, pairwise contextual similarity scores for behavior reasons associated with the current client. Classification system 136 may determine a behavior consistency score based on the pairwise contextual similarity scores. Classification system 136 may classify, based on the behavior consistency score, the current client into a category. Action system 138 may perform a communication action based on the category.

Furthermore, in some examples, classification system 136 computes a spatial similarity score. The spatial similarity score is a measure of a spatial proximity of behavior reasons in the graph. The spatial similarity score captures how closely related behavior reasons are related within the context of the clients' behavior patterns. To calculate the spatial similarity score, classification system 136 may determine the average shortest path length between all pairs of behavior reasons in the graph. This may involve measuring how easily one node can be reached from another node within the graph. For instance, classification system 136 may calculate the length of a shortest path between two nodes as a sum of the weights of the edges of the path. In some examples, classification system 136 may calculate the length of the shortest path between two nodes a total number of edges of the path. By averaging these average shortest path lengths, the spatial similarity score may provide an indication of the overall proximity and interconnectedness of the behavior reasons. A lower score may mean the behavior reasons are closely related and frequently transition between each other, while a higher spatial similarity score indicates more distant or less frequently connected topics. The spatial similarity score may help in understanding the spatial relationships among behavior reasons, providing valuable insights into the patterns and common themes in behavior reasons. In some examples, the spatial similarity score may be a cosine similarity score, a Jaccard similarity score, an Overlap coefficient, or another type of similarity score.

Classification system 136 may determine a BCS for a current client based on the spatial similarity score and the contextual similarity score for the current client. For example, classification system 136 may combine the spatial similarity score derived from the graph and the contextual similarity score (e.g., cosine similarity score) through a weighted sum to compute a behavior consistency score (BCS). In some examples, a weight for the spatial similarity score and a weight for the contextual similarity score are both 0.5, or may have other values. In other words, the behavior consistency score measures a consistency of a client's behavior reasons over time. If the BCS is greater than a threshold (e.g., 0.5), classification system 136 may classify the client as concordant; otherwise, classification system 136 may classify the client as divergent. This stratification may help in creating targeted strategies for behavior mitigation by distinguishing between members with consistent behavior reasons and those with varying reasons.

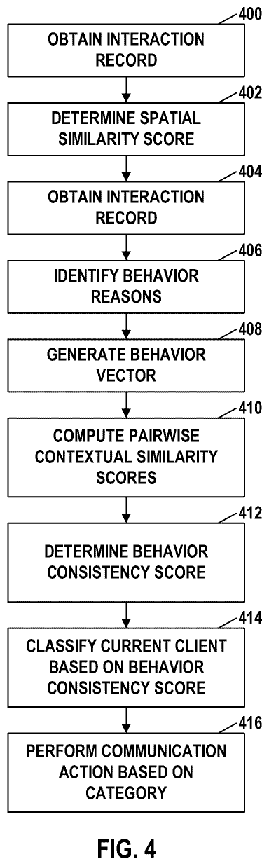

FIG. 4 is a flowchart illustrating an example operation of computing system 102 that performs a communication action based on a category of a client, in accordance with one or more techniques of this disclosure. The operation of FIG. 4 is a more detailed instance of the operation of FIG. 3. In the example of FIG. 4, vector generation system 132 may obtain a graph comprising a plurality of nodes and a plurality of edges (400). As in the example of FIG. 3, the nodes include behavior nodes that correspond to respective behavior reasons in a plurality of predefined behavior reasons, the predefined behavior reasons being reasons for behaviors of the clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node.

Additionally, vector generation system 132 may determine a spatial similarity score based on the graph (402). Vector generation system 132 may determine the spatial similarity score as described elsewhere in this disclosure. Furthermore, vector generation system 132 may obtain one or more interaction records (404). The one or more interaction records are records of interactions involving a current client. Vector generation system 132 may apply a trained ML model to the one or more interaction records to identify one or more behavior reasons associated with the current client (406). Vector generation system 132 may generate a behavior vector based on the one or more behavior reasons associated with the current client (408).

Furthermore, classification system 136 may compute, based on behavior vector of the current client, pairwise contextual similarity scores for behavior reasons associated with the current client (410). Classification system 136 may determine a behavior consistency score for the current client based on the pairwise contextual similarity scores and the spatial similarity score (412). Classification system 136 may classify, based on the behavior consistency score, the current client into a category (414). For example, classification system 136 may use the behavior consistency scores for the clients to classify the clients into a concordant group and a divergent category.

Action system 138 may perform a communication action with respect to the current client based on the category (416). For instance, action system 138 may select, based on the category, one or more applicable dialog units from among a plurality of dialog units. Action system 138 may output, for display on a display device, the one or more applicable dialog units.

The following is a non-limiting list of examples that are in accordance with one or more techniques of this disclosure.
Clause 1. A computer-implemented method comprising: obtaining, by one or more processors, a graph comprising a plurality of nodes and a plurality of edges, wherein: the nodes include behavior nodes that correspond to respective behavior reasons in a plurality of predefined behavior reasons, the predefined behavior reasons being reasons for behaviors of clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node; determining, by the one or more processors, a spatial similarity score based on the graph; obtaining, by the one or more processors, one or more interaction records, wherein the one or more interaction records are records of interactions involving a current client; applying, by the one or more processors, a trained machine learning (ML) model to the one or more interaction records to identify one or more behavior reasons associated with the current client; generating, by the one or more processors, a behavior vector based on the one or more behavior reasons associated with the current client; computing, by the one or more processors, based on behavior vector of the current client, pairwise contextual similarity scores for behavior reasons associated with the current client; determining a behavior consistency score for the current client based on the pairwise contextual similarity scores and the spatial similarity score; classifying, by the one or more processors, based on the behavior consistency score, the current client into a category; and performing, by the one or more processors, a communication action with respect to the current client based on the category.
Clause 2. The computer-implemented method of clause 1, wherein: the one or more processors obtain the one or more interaction records, identify the one or more behavior reasons, and generate the behavior vector during a real-time interaction between a representative of an organization and the current client, and the computer-implemented method further comprises, during the real-time interaction: predicting, by the one or more processors, based on the graph and the behavior vector, that the current client will have one or more next behavior reasons; selecting, by the one or more processors, a dialog unit to provide to the representative based on the one or more next behavior reasons; and outputting, by the one or more processors, the selected dialog unit to the representative.
Clause 3. The computer-implemented method of any of clauses 1-2, wherein: the one or more processors obtain the one or more interaction records, identify the one or more behavior reasons, and generate the behavior vector during a real-time interaction between a representative of an organization and the current client, the computer-implemented method further comprises, during the real-time interaction: predicting, by the one or more processors, based on the graph and the behavior vector, that the current client will have one or more next behavior reasons; determining, by the one or more processors, a document from a plurality of documents based on the one or more next behavior reasons; and outputting, by the one or more processors, commands to a machine to cause the machine to physically insert a physical copy of the document into a mail stream for delivery to the current client.
Clause 4. The computer-implemented method of any of clauses 1-3, wherein: the nodes of the graph further include one or more acceptance nodes that correspond to an acceptance behavior, and the computer-implemented method further comprises: determining, by the one or more processors and based on behavior vectors of a plurality of clients, current nodes associated with the clients, wherein, for each of the clients, a current node associated with the client is a node of the graph that corresponds to a current behavior reason of the client; and utilizing, by the one or more processors, the graph to determine lowest-cost paths for the clients through the graph from the current nodes associated with the clients to the one or more acceptance nodes, and performing the communication action comprises configuring, by the one or more processors, an auto-dialer system to prioritize dialing the clients based on costs of the lowest-cost paths for the clients.
Clause 5. The computer-implemented method of any of clauses 1-4, wherein: the nodes of the graph further include one or more acceptance nodes that correspond to acceptance behavior; the computer-implemented method further comprises: determining, by the one or more processors, based on the behavior vector associated with the current client, a current node associated with the current client, wherein the current node associated with the current client is a node of the graph that corresponds to a current behavior reason of the current client; utilizing, by the one or more processors, the graph to determine a lowest-cost path for the current client through the graph from the current node associated with the current client to the one or more acceptance nodes; determining, by the one or more processors, a document from a plurality of documents based on the lowest-cost path for the current client; and outputting, by the one or more processors, commands to one or more machines to cause the one or more machines to physically insert a physical copy of the determined document into a mail stream for delivery to the current client.
Clause 6. The computer-implemented method of any of clauses 1-5, wherein: the nodes of the graph further include one or more acceptance nodes that correspond to acceptance behaviors, the one or more processors obtain the one or more interaction records, identify the one or more behavior reasons, and generate the behavior vector during a real-time interaction between a representative and the current client, and the computer-implemented method further comprises, during the real-time interaction between the representative and the current client: determining, by the one or more processors, based on the behavior vector associated with the current client, a current node associated with the current client, wherein the current node associated with the current client is a node of the graph that corresponds to a current behavior reason of the current client; utilizing, by the one or more processors, the graph to determine a lowest-cost path for the current client through the graph from the current node associated with the current client to the one or more acceptance nodes; selecting, by the one or more processors, based on the lowest-cost path for the current client, one or more applicable dialog units from among a plurality of dialog units; and outputting, by the one or more processors, for display on a display device, the one or more applicable dialog units.
Clause 7. The computer-implemented method of any of clauses 1-6, wherein obtaining the graph comprises applying, by the one or more processors, a Hidden Markov Model (HMM) that calculates weights associated with the edges based on behavior vectors.
Clause 8. The computer-implemented method of any of clauses 1-7, wherein performing the communication action comprises: selecting, by the one or more processors, based on the category, one or more applicable dialog units from among a plurality of dialog units; and outputting, by the one or more processors, for display on a display device, the one or more applicable dialog units.
Clause 9. The computer-implemented method of any of clauses 1-8, wherein: the trained ML model is a first trained ML model and the communication action is a first communication action, and the computer-implemented method further comprises: applying, by the one or more processors, a second trained ML model to a sequence of behavior vectors associated with the current client to predict a next behavior topic associated with the current client; and performing, by the one or more processors, a second communication action based on the next behavior topic.
Clause 10. The computer-implemented method of any of clauses 1-9, wherein generating the behavior vector comprises applying a Bidirectional Encoder Representations from Transformers (BERT) model to generate the behavior vector based on the one or more behavior reasons associated with the current client.
Clause 11. A computing system comprising: one or more processors; and one or more memories storing processor-executable instructions that, when executed by the one or more processors, cause the one or more processors to perform operations comprising: obtaining a graph comprising a plurality of nodes and a plurality of edges, wherein: the nodes include behavior nodes that correspond to respective behavior reasons in a plurality of predefined behavior reasons, the predefined behavior reasons being reasons for behaviors of clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node; determining a spatial similarity score based on the graph; obtaining one or more interaction records, wherein the one or more interaction records are records of interactions involving a current client; applying a trained machine learning (ML) model to the one or more interaction records to identify one or more behavior reasons associated with the current client; generating a behavior vector based on the one or more behavior reasons associated with the current client; computing, based on behavior vector of the current client, pairwise contextual similarity scores for behavior reasons associated with the current client; determining a behavior consistency score for the current client based on the pairwise contextual similarity scores and the spatial similarity score; classifying, based on the behavior consistency score, the current client into a category; and performing a communication action with respect to the current client based on the category.
Clause 12. The computing system of clause 11, wherein: the one or more processors obtain the one or more interaction records, identify the one or more behavior reasons, and generate the behavior vector during a real-time interaction between a representative of an organization and the current client, the operations further comprise, during the real-time interaction: predicting, based on the graph and the behavior vector, that the current client will have one or more next behavior reasons; selecting a dialog unit to provide to the representative based on the one or more next behavior reasons; and outputting the selected dialog unit to the representative.
Clause 13. The computing system of any of clauses 11-12, wherein: the one or more processors obtain the one or more interaction records, identify the one or more behavior reasons, and generate the behavior vector during a real-time interaction between a representative of an organization and the current client, the operations further comprise, during the real-time interaction: predicting, based on the graph and the behavior vector, that the current client will have one or more next behavior reasons; determining a document from a plurality of documents based on the one or more next behavior reasons; and outputting commands to a machine to cause the machine to physically insert a physical copy of the document into a mail stream for delivery to the current client.
Clause 14. The computing system of any of clauses 11-13, wherein: the nodes of the graph further include one or more acceptance nodes that correspond to acceptance behavior, and the operations further comprise: determining, based on behavior vectors of a plurality of clients, current nodes associated with the clients, wherein, for each of the clients, a current node associated with the client is a node of the graph that corresponds to a current behavior reason of the client; and utilizing the graph to determine lowest-cost paths for the clients through the graph from the current nodes associated with the clients to the one or more acceptance nodes, and performing the communication action comprises configuring an auto-dialer system to prioritize dialing the clients based on costs of the lowest-cost paths for the clients.
Clause 15. The computing system of any of clauses 11-14, wherein: the nodes of the graph further include one or more acceptance nodes that correspond to acceptance behavior; the operations further comprise: determining, based on the behavior vector associated with the current client, a current node associated with the current client, wherein the current node associated with the current client is a node of the graph that corresponds to a current behavior reason of the current client; utilizing the graph to determine a lowest-cost path for the current client through the graph from the current node associated with the current client to the one or more acceptance nodes; determining a document from a plurality of documents based on the lowest-cost path for the current client; and outputting commands to one or more machines to cause the one or more machines to physically insert a physical copy of the determined document into a mail stream for delivery to the current client.
Clause 16. The computing system of any of clauses 11-15, wherein: the nodes of the graph further include one or more acceptance nodes that correspond to acceptance behavior, the one or more processors obtain the one or more interaction records, identify the one or more behavior reasons, and generate the behavior vector during a real-time interaction between a representative and the current client, and the operations further comprise, during the real-time interaction between the representative and the current client: determining, based on the behavior vector associated with the current client, a current node associated with the current client, wherein the current node associated with the current client is a node of the graph that corresponds to a current behavior reason of the current client; utilizing the graph to determine a lowest-cost path for the current client through the graph from the current node associated with the current client to the one or more acceptance nodes; selecting, based on the lowest-cost path for the current client, one or more applicable dialog units from among a plurality of dialog units; and outputting, for display on a display device, the one or more applicable dialog units.
Clause 17. The computing system of any of clauses 11-16, wherein obtaining the graph comprises applying a Hidden Markov Model (HMM) that calculates weights associated with the edges based on behavior vectors.
Clause 18. The computing system of any of clauses 11-17, wherein performing the communication action comprises: selecting, by the one or more processors, based on the category, one or more applicable dialog units from among a plurality of dialog units; and outputting, by the one or more processors, for display on a display device, the one or more applicable dialog units.
Clause 19. The computing system of any of clauses 11-18, wherein: the trained ML model is a first trained ML model and the communication action is a first communication action, and the operations further comprise: applying a second trained ML model to a sequence of behavior vectors associated with the current client to predict a next behavior topic associated with the current client; and performing a second communication action based on the next behavior topic.
Clause 20. One or more non-transitory computer-readable storage media having processor-executable instructions stored thereon that, when executed by one or more processors, cause the one or more processors to: obtain a graph comprising a plurality of nodes and a plurality of edges, wherein: the nodes include behavior nodes that correspond to respective behavior reasons in a plurality of predefined behavior reasons, the predefined behavior reasons being reasons for behaviors of clients, the edges correspond to transitions between the nodes and are associated with weights, and for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node; determine a spatial similarity score based on the graph; obtain one or more interaction records, wherein the one or more interaction records are records of interactions involving a current client; apply a trained machine learning (ML) model to the one or more interaction records to identify one or more behavior reasons associated with the current client; generate a behavior vector based on the one or more behavior reasons associated with the current client; compute, based on behavior vector of the current client, pairwise contextual similarity scores for behavior reasons associated with the current client; determining a behavior consistency score for the current client based on the pairwise contextual similarity scores and the spatial similarity score; classify, based on the behavior consistency score, the current client into a category; and perform a communication action with respect to the current client based on the category.

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
obtaining, by one or more processors, a graph comprising a plurality of nodes and a plurality of edges, wherein:
the nodes include behavior nodes that correspond to respective behavior reasons in a plurality of predefined behavior reasons, the predefined behavior reasons being reasons for behaviors of clients,
the edges correspond to transitions between the nodes and are associated with weights, and
for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node;
determining, by the one or more processors, a spatial similarity score based on the graph;
obtaining, by the one or more processors, one or more interaction records, wherein the one or more interaction records are records of interactions involving a current client;
applying, by the one or more processors, a trained machine learning (ML) model to the one or more interaction records to identify one or more behavior reasons associated with the current client;
generating, by the one or more processors, a behavior vector based on the one or more behavior reasons associated with the current client;
computing, by the one or more processors, based on behavior vector of the current client, pairwise contextual similarity scores for behavior reasons associated with the current client;
determining a behavior consistency score for the current client based on the pairwise contextual similarity scores and the spatial similarity score;
classifying, by the one or more processors, based on the behavior consistency score, the current client into a category; and
performing, by the one or more processors, a communication action with respect to the current client based on the category.

2. The computer-implemented method of claim 1, wherein:
the one or more processors obtain the one or more interaction records, identify the one or more behavior reasons, and generate the behavior vector during a real-time interaction between a representative of an organization and the current client, and
the computer-implemented method further comprises, during the real-time interaction:
predicting, by the one or more processors, based on the graph and the behavior vector, that the current client will have one or more next behavior reasons;
selecting, by the one or more processors, a dialog unit to provide to the representative based on the one or more next behavior reasons; and
outputting, by the one or more processors, the selected dialog unit to the representative.

3. The computer-implemented method of claim 1, wherein:
the one or more processors obtain the one or more interaction records, identify the one or more behavior reasons, and generate the behavior vector during a real-time interaction between a representative of an organization and the current client,
the computer-implemented method further comprises, during the real-time interaction:
predicting, by the one or more processors, based on the graph and the behavior vector, that the current client will have one or more next behavior reasons;
determining, by the one or more processors, a document from a plurality of documents based on the one or more next behavior reasons; and
outputting, by the one or more processors, commands to a machine to cause the machine to physically insert a physical copy of the document into a mail stream for delivery to the current client.

4. The computer-implemented method of claim 1, wherein:
the nodes of the graph further include one or more acceptance nodes that correspond to an acceptance behavior, and
the computer-implemented method further comprises:
determining, by the one or more processors and based on behavior vectors of a plurality of clients, current nodes associated with the clients, wherein, for each of the clients, a current node associated with the client is a node of the graph that corresponds to a current behavior reason of the client; and
utilizing, by the one or more processors, the graph to determine lowest-cost paths for the clients through the graph from the current nodes associated with the clients to the one or more acceptance nodes, and
performing the communication action comprises configuring, by the one or more processors, an auto-dialer system to prioritize dialing the clients based on costs of the lowest-cost paths for the clients.

5. The computer-implemented method of claim 1, wherein:
the nodes of the graph further include one or more acceptance nodes that correspond to acceptance behavior;
the computer-implemented method further comprises:
determining, by the one or more processors, based on the behavior vector associated with the current client, a current node associated with the current client, wherein the current node associated with the current client is a node of the graph that corresponds to a current behavior reason of the current client;
utilizing, by the one or more processors, the graph to determine a lowest-cost path for the current client through the graph from the current node associated with the current client to the one or more acceptance nodes;
determining, by the one or more processors, a document from a plurality of documents based on the lowest-cost path for the current client; and
outputting, by the one or more processors, commands to one or more machines to cause the one or more machines to physically insert a physical copy of the determined document into a mail stream for delivery to the current client.

6. The computer-implemented method of claim 1, wherein:
the nodes of the graph further include one or more acceptance nodes that correspond to acceptance behaviors,
the one or more processors obtain the one or more interaction records, identify the one or more behavior reasons, and generate the behavior vector during a real-time interaction between a representative and the current client, and
the computer-implemented method further comprises, during the real-time interaction between the representative and the current client:
determining, by the one or more processors, based on the behavior vector associated with the current client, a current node associated with the current client, wherein the current node associated with the current client is a node of the graph that corresponds to a current behavior reason of the current client;
utilizing, by the one or more processors, the graph to determine a lowest-cost path for the current client through the graph from the current node associated with the current client to the one or more acceptance nodes;
selecting, by the one or more processors, based on the lowest-cost path for the current client, one or more applicable dialog units from among a plurality of dialog units; and
outputting, by the one or more processors, for display on a display device, the one or more applicable dialog units.

7. The computer-implemented method of claim 1, wherein obtaining the graph comprises applying, by the one or more processors, a Hidden Markov Model (HMM) that calculates weights associated with the edges based on behavior vectors.

8. The computer-implemented method of claim 1, wherein performing the communication action comprises:
selecting, by the one or more processors, based on the category, one or more applicable dialog units from among a plurality of dialog units; and
outputting, by the one or more processors, for display on a display device, the one or more applicable dialog units.

9. The computer-implemented method of claim 1, wherein:
the trained ML model is a first trained ML model and the communication action is a first communication action, and
the computer-implemented method further comprises:
applying, by the one or more processors, a second trained ML model to a sequence of behavior vectors associated with the current client to predict a next behavior topic associated with the current client; and
performing, by the one or more processors, a second communication action based on the next behavior topic.

10. The computer-implemented method of claim 1, wherein generating the behavior vector comprises applying a Bidirectional Encoder Representations from Transformers (BERT) model to generate the behavior vector based on the one or more behavior reasons associated with the current client.

11. A computing system comprising:
one or more processors; and
one or more memories storing processor-executable instructions that, when executed by the one or more processors, cause the one or more processors to perform operations comprising:
obtaining a graph comprising a plurality of nodes and a plurality of edges, wherein:
the nodes include behavior nodes that correspond to respective behavior reasons in a plurality of predefined behavior reasons, the predefined behavior reasons being reasons for behaviors of clients,
the edges correspond to transitions between the nodes and are associated with weights, and
for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node;
determining a spatial similarity score based on the graph;
obtaining one or more interaction records, wherein the one or more interaction records are records of interactions involving a current client;
applying a trained machine learning (ML) model to the one or more interaction records to identify one or more behavior reasons associated with the current client;
generating a behavior vector based on the one or more behavior reasons associated with the current client;
computing, based on behavior vector of the current client, pairwise contextual similarity scores for behavior reasons associated with the current client;
determining a behavior consistency score for the current client based on the pairwise contextual similarity scores and the spatial similarity score;
classifying, based on the behavior consistency score, the current client into a category; and
performing a communication action with respect to the current client based on the category.

12. The computing system of claim 11, wherein:
the one or more processors obtain the one or more interaction records, identify the one or more behavior reasons, and generate the behavior vector during a real-time interaction between a representative of an organization and the current client,
the operations further comprise, during the real-time interaction:
predicting, based on the graph and the behavior vector, that the current client will have one or more next behavior reasons;
selecting a dialog unit to provide to the representative based on the one or more next behavior reasons; and
outputting the selected dialog unit to the representative.

13. The computing system of claim 11, wherein:
the one or more processors obtain the one or more interaction records, identify the one or more behavior reasons, and generate the behavior vector during a real-time interaction between a representative of an organization and the current client,
the operations further comprise, during the real-time interaction:
predicting, based on the graph and the behavior vector, that the current client will have one or more next behavior reasons;
determining a document from a plurality of documents based on the one or more next behavior reasons; and
outputting commands to a machine to cause the machine to physically insert a physical copy of the document into a mail stream for delivery to the current client.

14. The computing system of claim 11, wherein:
the nodes of the graph further include one or more acceptance nodes that correspond to acceptance behavior, and
the operations further comprise:
determining, based on behavior vectors of a plurality of clients, current nodes associated with the clients, wherein, for each of the clients, a current node associated with the client is a node of the graph that corresponds to a current behavior reason of the client; and
utilizing the graph to determine lowest-cost paths for the clients through the graph from the current nodes associated with the clients to the one or more acceptance nodes, and performing the communication action comprises configuring an auto-dialer system to prioritize dialing the clients based on costs of the lowest-cost paths for the clients.

15. The computing system of claim 11, wherein:
the nodes of the graph further include one or more acceptance nodes that correspond to acceptance behavior;
the operations further comprise:
determining, based on the behavior vector associated with the current client, a current node associated with the current client, wherein the current node associated with the current client is a node of the graph that corresponds to a current behavior reason of the current client;
utilizing the graph to determine a lowest-cost path for the current client through the graph from the current node associated with the current client to the one or more acceptance nodes;
determining a document from a plurality of documents based on the lowest-cost path for the current client; and
outputting commands to one or more machines to cause the one or more machines to physically insert a physical copy of the determined document into a mail stream for delivery to the current client.

16. The computing system of claim 11, wherein:
the nodes of the graph further include one or more acceptance nodes that correspond to acceptance behavior,
the one or more processors obtain the one or more interaction records, identify the one or more behavior reasons, and generate the behavior vector during a real-time interaction between a representative and the current client, and
the operations further comprise, during the real-time interaction between the representative and the current client:
determining, based on the behavior vector associated with the current client, a current node associated with the current client, wherein the current node associated with the current client is a node of the graph that corresponds to a current behavior reason of the current client;
utilizing the graph to determine a lowest-cost path for the current client through the graph from the current node associated with the current client to the one or more acceptance nodes;
selecting, based on the lowest-cost path for the current client, one or more applicable dialog units from among a plurality of dialog units; and
outputting, for display on a display device, the one or more applicable dialog units.

17. The computing system of claim 11, wherein obtaining the graph comprises applying a Hidden Markov Model (HMM) that calculates weights associated with the edges based on behavior vectors.

18. The computing system of claim 11, wherein performing the communication action comprises:
selecting, by the one or more processors, based on the category, one or more applicable dialog units from among a plurality of dialog units; and
outputting, by the one or more processors, for display on a display device, the one or more applicable dialog units.

19. The computing system of claim 11, wherein:
the trained ML model is a first trained ML model and the communication action is a first communication action, and
the operations further comprise:
applying a second trained ML model to a sequence of behavior vectors associated with the current client to predict a next behavior topic associated with the current client; and
performing a second communication action based on the next behavior topic.

20. One or more non-transitory computer-readable storage media having processor-executable instructions stored thereon that, when executed by one or more processors, cause the one or more processors to:
obtain a graph comprising a plurality of nodes and a plurality of edges, wherein:
the nodes include behavior nodes that correspond to respective behavior reasons in a plurality of predefined behavior reasons, the predefined behavior reasons being reasons for behaviors of clients,
the edges correspond to transitions between the nodes and are associated with weights, and
for each respective edge of the plurality of edges that corresponds to a transition from any first behavior node to any second behavior node, the respective edge is associated with a weight that corresponds to a probability of the clients having a behavior reason associated with the second behavior node after having a behavior reason associated with the first behavior node;
determine a spatial similarity score based on the graph;
obtain one or more interaction records, wherein the one or more interaction records are records of interactions involving a current client;
apply a trained machine learning (ML) model to the one or more interaction records to identify one or more behavior reasons associated with the current client;
generate a behavior vector based on the one or more behavior reasons associated with the current client;
compute, based on behavior vector of the current client, pairwise contextual similarity scores for behavior reasons associated with the current client;
determining a behavior consistency score for the current client based on the pairwise contextual similarity scores and the spatial similarity score;
classify, based on the behavior consistency score, the current client into a category; and
perform a communication action with respect to the current client based on the category.
